(19) United States
(12) Patent Application Publication
(10) Pub. No.: US 2006/0212489 A1
(43) Pub. Date: Sep. 21, 2006

(54) Technique for effectively synchronizing data through an information service

(76) Inventor: Michael R. Eggers, Portland, OR (US)

Correspondence Address: Alex L. Yip;c/o Kaye Scholer LLP, 425 Park Avenue, New York, NY, 10022, US

(21) Appl. No.: 11/079,948

(22) Filed: Mar. 15, 2005

(51) Int. Cl. G06F 17/30

(52) U.S. Cl. 707/201

(57) ABSTRACT

A user may utilize a communication device, e.g., a wireless phone, mobile device or personal digital assistant (PDA), to access an information assistance system where an operator may provide personalized information and communications services to the user. In addition, the information assistance system may provide an information management service for maintaining personal contacts folders (also known as “private directories”) and appointments folders for a user. To effectively data-synchronize such contacts folders and appointments folders with the corresponding files in the user's personal information managers (PIMs), representations of such folders and PIM files (e.g., CRC codes therefor) are generated for ease of identifying any changes in their contents since the last data synchronization.

### FIELD OF THE INVENTION

The invention relates to a communication system and method, and more particularly to an information system and method for facilitating synchronization of data in user devices through an information service.

### BACKGROUND OF THE INVENTION

In this information age, people need to be well informed and organized to effectively carry out day-to-day activities, especially when they are traveling and away from their “home” base where they normally conduct their business. As a result, use of mobile devices which facilitate mobile communications such as personal digital assistants (PDAs), and wireless phones and devices is ubiquitous. For example, PDAs allow users to store and organize their appointments, to-do lists and contacts information. Some PDAs also allow the users to access the Internet to upload and download information, and communicate with other people and information sources via email.

Similarly, wireless phones conveniently allow users while traveling to call and communicate with other people. In case the users cannot remember the telephone number of a contact or it is not handy, or the users want to obtain directions and other information concerning, e.g., restaurants, theaters, etc., they can call operators for assistance. To that end, an expansive network of communication call centers has been established which provides users with nationwide assistance.

In order to effectively utilize the prior art operator assistance service, the service needs to be improved and, more particularly, personalized to the extent comparable to the personal assistance afforded by a user's personal aide or secretary. Some desirable personalized information assistance service features have been described, e.g., in copending commonly assigned application Ser. No. 09/865,230 (“the '230 application”) filed on May 25, 2001, hereby incorporated by reference. In particular, the '230 application discloses an information assistance service which as part of the service maintains, for the user, contacts folders (also known as “private directories”), appointments folders, to-do lists, etc. The user may access, through the information assistance service, contact information, appointment information or a to-do list item in the respective folders associated with the user. In particular, a contacts folder contains contact information, such as a telephone number(s), an address(es), and e-mail address(es), for people and/or organizations. A user may have separate contacts folders for different purposes, such as a personal contacts folder, business contacts folder, etc. An appointments folder contains a user's appointment and/or calendar information, and a user may similarly have separate appointments folders for different purposes.

However, for accessibility reasons, a user may maintain and utilize other data sources, e.g., a work computer, home computer, PDA, etc. and different software applications, to manage contact information, appointment information, etc. Synchronization between the data sources and the aforementioned folders is important to ensure a uniform update of the data sources and folders.

### SUMMARY OF THE INVENTION

The invention is premised upon a recognition that although prior art synchronization techniques generally are effective, the synchronization processes according to these techniques are undesirably slow even when there were no changes to the information being synchronized. In accordance with the invention, an information service maintains a first data source including, e.g., the aforementioned appointments and contacts folders for a user. A first representation of synchronized content is maintained which results from a previous synchronization of contents of the first data source and a second data source. A second representation of content of the first data source and a third representation of content of the second data source are generated after the previous synchronization. Comparisons of the first representation with the second representation and that with the third representation are made to determine a change in the content of the first data source and/or the second data source since the previous synchronization. The current synchronization between the two data sources is performed based on such a change.

### BRIEF DESCRIPTION OF THE DRAWING

Further objects, features and advantages of the invention will become apparent from the following detailed description taken in conjunction with the accompanying drawing showing an illustrative embodiment of the invention, in which:

FIG. 1 illustrates a communications system including information/call centers in accordance with the invention;

FIGS. 2A and 2B are block diagrams of components of the communications system of FIG. 1;

FIG. 3 illustrates a Login graphical user interface (GUI) of an information management service provide by the communications system of FIG. 1;

FIG. 4 illustrates a Home GUI;

FIG. 5 illustrates an Edit GUI;

FIG. 6 illustrates a GUI containing contact information;

FIG. 7 illustrates a View GUI;

FIG. 8 illustrates a GUI particularly useful for an operator to search for directory information concerning a desired party;

FIG. 9 illustrates a computer having a programmed personal information manager (PIM) function;

FIG. 10 illustrates a contacts folder maintained by the information management service, in accordance with the invention;

FIG. 11 illustrates a synchronization reference table for use in data synchronization in accordance with the invention;

FIGS. 12A and 12B are flow charts depicting a data synchronization process in accordance with the invention; and

FIG. 13 illustrates a user GUI for resolving a data conflict during the synchronization process.

### DETAILED DESCRIPTION

The invention is directed to providing personalized information and communications services to users, e.g., telephone and mobile device users, especially when they are away from their “home” base where they normally conduct their business. An objective of the invention is to provide the users with personalized services comparable to those which are offered by the users' personal aides or secretaries. To that end, an information assistance service in accordance with the invention utilizes such information management tools as contacts folders (also known as private directories), appointments folders, to-do lists, etc. to effectively communicate dynamic information to the users.

A user of the personalized information assistance service may want to create multiple contacts (appointments) folders for different purposes. For example, they may include a personal contacts (appointments) folder containing personal directory (calendar) information, and a business contacts (appointments) folder containing business directory (calendar) information. With the present information management service, a contacts (appointments) folder may be created and maintained (1) through the Internet or other network or communications means directly, (2) through an operator indirectly, and/or (3) using a personal information manager (PIM). Well known PIMs include, e.g., hand-held devices such as personal digital assistants (PDAs) and wireless communicators; and computer devices such as notebook, laptop and desktop computers running software applications such as Microsoft Outlook, Outlook Express, Goldmine, Symantec Act!, Lotus Organizer and Lotus Notes. Other PIMs may include proprietary PIM systems and applications. It should be pointed out that the term “operator” used herein broadly encompasses entities that are capable of providing assistance in a telecommunication environment, including without limitation human operators, voice response/recognition capabilities, web-enabled operator services, and other automated and electronic access.

In case (2) above, the user may access a contacts (appointments) folder through communications with an operator at an information/call center via telecommunication media, e.g., wireless telephone, wireline telephone, voice over Internet protocol (VoIP), PDA, VPN, etc. In case (3), by applying a synchronization technique in accordance with the invention, the user may update directory information which has been changed (added, edited or deleted) in a PIM data source in the corresponding contacts (appointments) folder, and vice versa. The invention is premised upon a recognition that although prior art synchronization techniques generally are effective, the synchronization processes according to these techniques are undesirably slow even when there were no changes to the information being synchronized. In accordance with the invention, a synchronization server registers a first representation of content of a contacts (appointments) folder as of the last synchronization, and generates a second representation of content of the contacts (appointments) folder after the last synchronization. In one embodiment, during a current synchronization, the synchronization server also generates a third representation of content of a data source to be synchronized with the contacts (appointments) folder. The first representation is then compared with the second and third representations, respectively. If the representations are the same, the server may conclude that no changes have been made to the folder and corresponding data source since the last synchronization, and may end the synchronization process instantly. By contrast, the prior art techniques may arrive at the same conclusion by comparing each entry of the folder with the corresponding entry of the data source, which comparison is time-consuming.

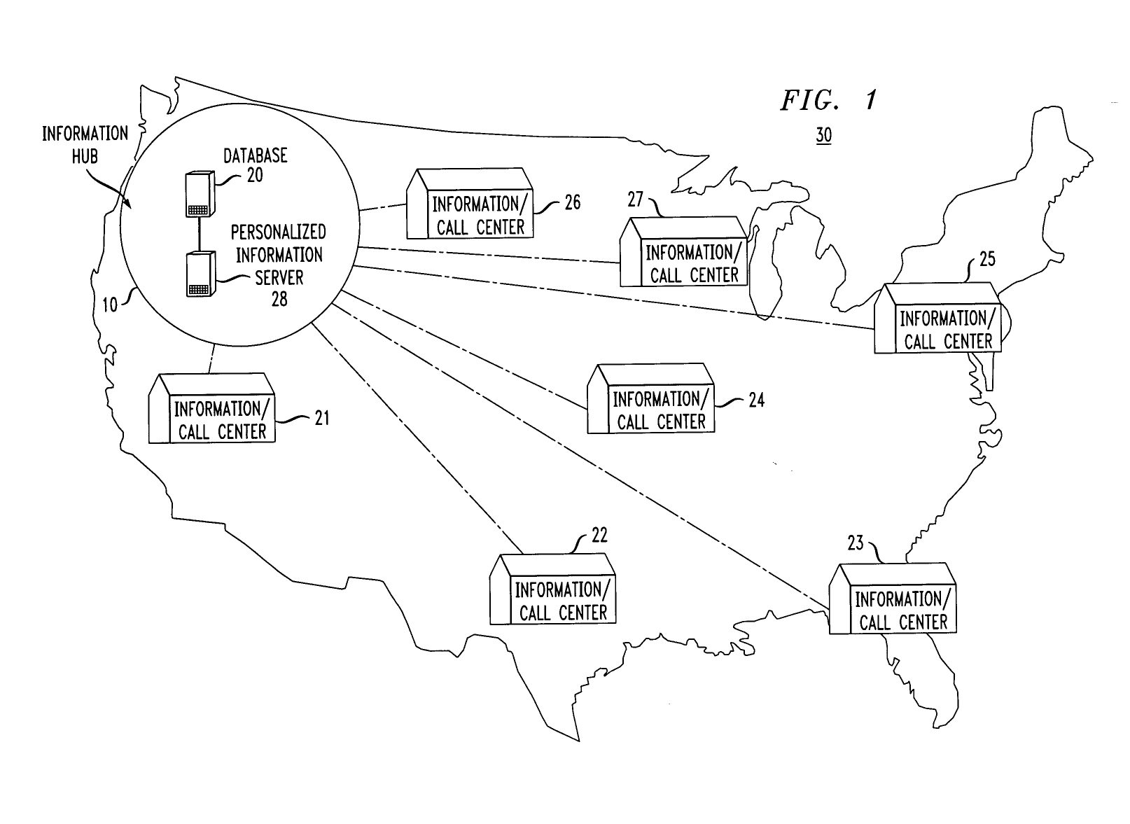

FIG. 1 illustrates a communications system embodying the principles of the invention for providing, inter alia, a personalized information assistance service. This communication system includes wide area network (WAN) 30 covering an extensive area. WAN 30 may be an Internet-based network such as the World Wide Web or a private intranet based network. WAN 30 connects operators dispersed throughout a wide coverage area in information/call centers 21 through 27. One or more information hubs 10 are also included in WAN 30. An information hub 10 includes one or more personalized information servers 28 which are accessible by the operators in the system, and one or more databases 20 in which subscribers' information, and contacts, appointments, and other folders (e.g., to-do lists) may be stored and maintained. Such information and folders may also be stored locally at one or more of the information/call centers.

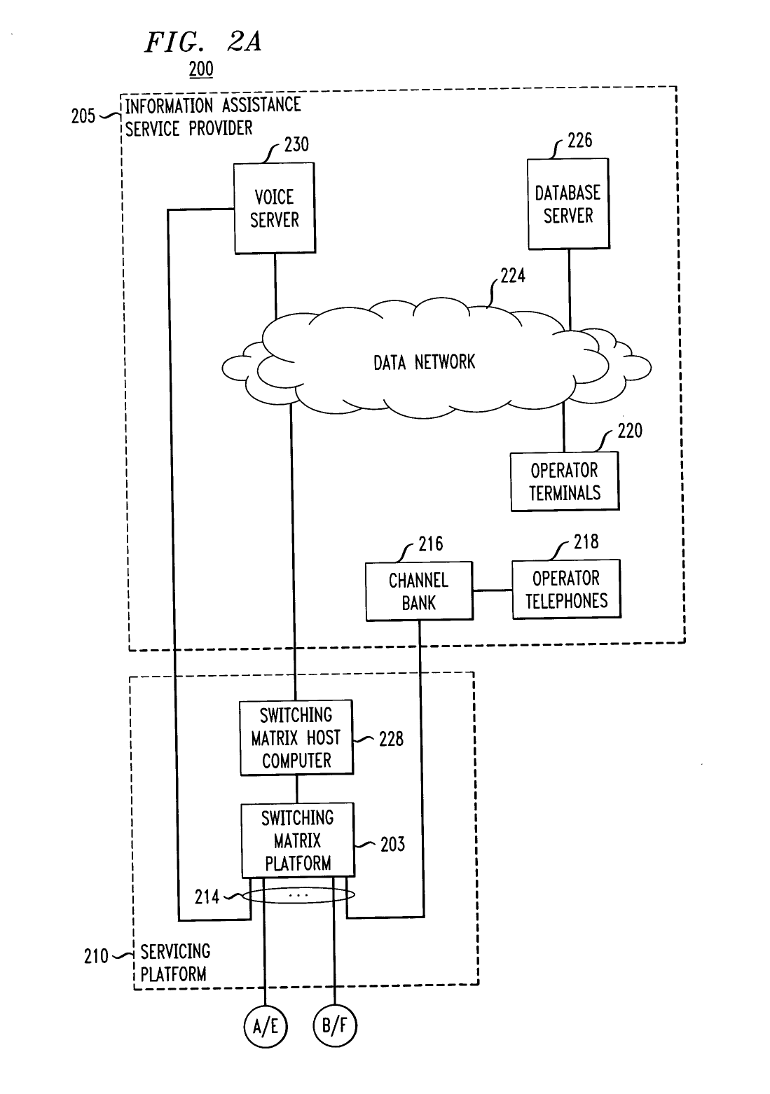

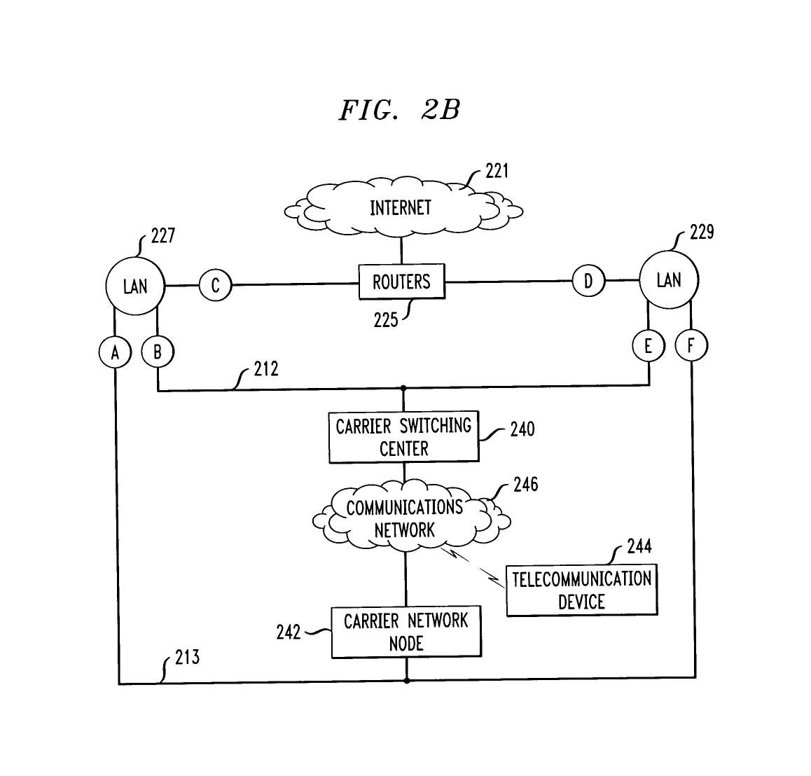

Referring to FIGS. 2A and 2B, information/call center 200 (which generically represents one of aforementioned information/call centers 21 through 27) is attended by operators, which includes information assistance service provider 205 and servicing platform 210. It should be noted that even though both provider 205 and servicing platform 210 appear in the same figure, they may or may not be located in the same geographic area. Servicing platform 210 comprises switching matrix host computer 228, and switching matrix platform 203 which is connected via T1 communication links 214 to, among others, voice server 230 and channel bank 216 in provider 205.

Channel bank 216 is used to couple multiple operator telephones 218 to platform 203. The operators in center 200 are further equipped with operator terminals 220, each of which includes a video display unit and a keyboard with associated dialing pad. Operator terminals 220 are connected over data network 224 to one or more database server(s) 226 (although only one is shown here). Database server 226 provides access to, among others, directory information from multiple sources. Database server 226 enables the operator to search directory information not just by name and address (sometimes city or area code) of a desired party, but also by type of goods/services and/or geographical region of a desired entity. Data network 224 further connects to voice server 230, user profile gateway 231, and switching matrix host computer 228, which in turn is connected to switching matrix platform 203 via a data link. Data network 224 includes, but is not limited to, local area network (LAN) 227, best seen in FIG. 2B. LAN 227 may connect to other similar remote LANs 229 to form WAN 30 in FIG. 1. LANs 227 and 229 are connected to one another and to Internet 221 via routers 225.

A user's telephone, computer, PDA or other telecommunication device 244 communicates via communications network 246 which is connected to carrier network node 242 and carrier switching center 240. T1 voice links 212 provide connection between the information/call center's switching matrix platform 203 and carrier's switching center 240, through which incoming information service calls are received. T1 voice links 212 further provide connection to the carrier switching center 240 through which outgoing calls are placed over communications network 246 (which network may be different than that used for incoming calls). Similarly, T1 data links 213 provide a signaling connection between the information/call center's node (not shown) and carrier network node 242, through which incoming and outgoing signaling messages are transported. The information/call center node is contained within switching matrix platform 203, but one with skill in the art will appreciate that the information/call center node could also be a physically distinct component. If the outgoing call is being placed over a different network than that on which the incoming call was received, a second data connection to the outgoing network will be established. The operation of switching matrix platform 203 is governed by computer-readable instructions stored and executed on switch matrix host computer 228. In this illustrative embodiment, platform 203 includes, inter alia, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on center 200 and platform 203 for each corresponding function.

Voice server 230 is connected via data network 224 to computer 228 (to which it acts as a slave processor) and via one or more T1 links to switching matrix platform 203. Each voice server 230 when more than one is employed in information/call center 200, connects to switching matrix platform 203 via a separate T1 link. Voice server 230 comprises a general purpose computer incorporating one or more voice cards, which serve as the interface between server 230 and the T1 span to switching matrix platform 203. One such voice card in server 230 monitors and controls communications over the T1 span. Its capabilities include telephone tone (e.g., DTMF or MF) detection and generation, voice recording and playback, and call progress analysis. Voice server 230 in this instance also contains a voice recognition device for receiving verbal input from a party connected thereto. Voice server 230 is employed to play the constantly repeated parts of an operator's speech, namely, the various greetings and signoffs (or closings), the caller's desired telephone number where requested, and possibly other information. At appropriate stages in a call progression, switch matrix host computer 228 initiates a voice path connection between voice server 30 and switching matrix platform 203 such that the user, or the user and the operator, are able to hear whatever pre-recorded speech is played on that connection by voice server 230. Computer 228 then instructs voice server 230, via data network 224, what type of message to play, and passes data parameters that enable voice server 230 to locate the message appropriate to the call state.

Users of a particular telephone carrier may dial, speak or otherwise communicate predetermined access digits, access codes or retail numbers, or input a predetermined address or a URL established for information assistance by that company. The instant example assumes that the user dials, e.g., “411,” “*555,” “555-1212,” “1-800-555-1212,” “00,” “1-888-411-1111” or other designated access numbers. The participating telephone company's own switching system will then reroute the call to information/call center 200 (via a T1 channel), where it appears as an incoming call.

Automatic call distribution (ACD) logic is used to queue (if necessary) and distribute calls to operators in the order in which they are received, and such that the call traffic is distributed evenly among the operators. In other embodiments, other distribution logic schemes may be utilized, such as skills-based routing based on, e.g., a preferred call handling method specified by a user profile, or a priority scheme for preferred callers. The queue is maintained by switching matrix host computer 228.

As mentioned before, a user may create, maintain or access one or more contacts folders (or other folders such as a personal or company appointments/calendar folders) via the Internet or other network or communications means, or through an operator who in turn may create, maintain or access the folder on behalf of the user. In this illustrative embodiment, two contacts folders associated with the user, e.g., “My Contacts” and “Company Contacts” folders, are maintained and stored in database 20.

When the user uses telecommunication device 244, e.g., a wireless telephone, to call an operator at a designated access number for information assistance, the call is routed to, say, information/call center 200. Referring back to FIG. 2A, an information assistance call is received by switching matrix platform 203 in center 200. In a well known manner, platform 203 derives, from the call set-up signals associated with the call, an automatic number identification (ANI) indicating the telephone number of the communication device from which the call originates. Switching matrix host computer 228 may request, for example, from server 28 through data network 224, any stored user profile record containing user preferences (e.g., foreign language preference), which is identified by such an ANI. The call may then be handled according to any such user preferences, e.g., transferring the call to an appropriate operator who speaks the user's preferred language.

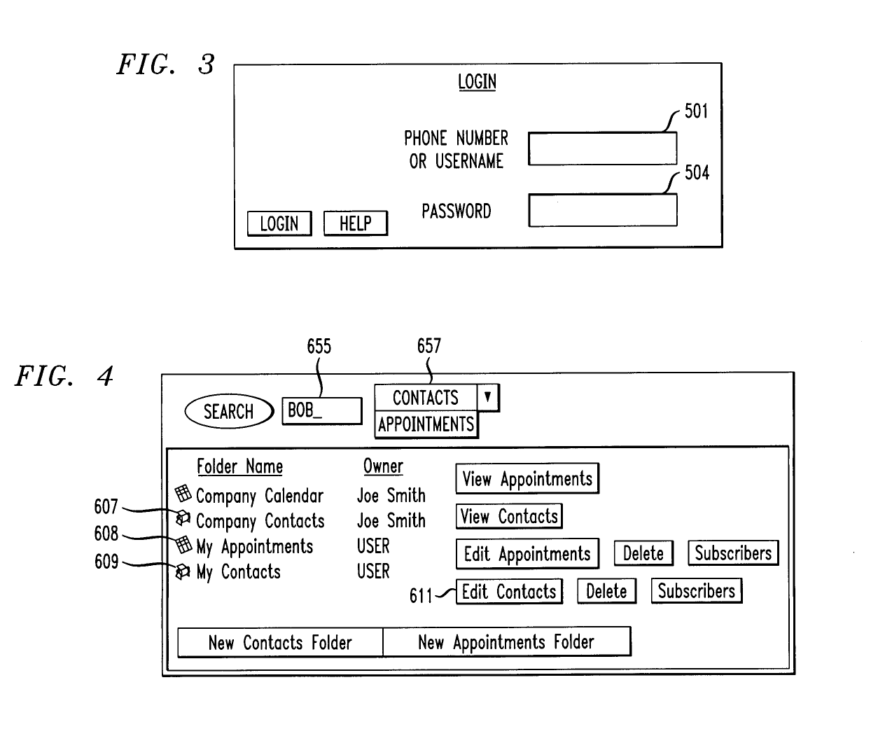

A Login graphical user interface (GUI) may have been displayed on terminal 220 of the operator answering the call. FIG. 3 illustrates such a GUI where the operator is prompted to enter the user's phone number or username to identify the user, and a password to check whether the user is authorized to access the personalized information management service. It will be appreciated that other user identifying information, e.g., a PIN, mother's maiden name, voiceprint, etc. may be used for verification purposes as well.

It should be noted at this point that the user identification and password are established beforehand through a registration process. For example, to subscribe to the personalized information service, the user can call an operator at the designated access number. As part of the registration, the operator enters in a user data record on server 28 the user identifying information including username, password, and telephone number of the particular telecommunication device, e.g., a wireless telephone in this instance, which the user would use to call the information assistance service in the future. It is particularly advantageous to use such a phone number (also known as a mobile directory number (MDN) in the case of a wireless phone number) to identify the user since, as described before, the calling number would be automatically captured as an ANI at information/call center 200 when the user calls.

Thus, the ANI of the user is automatically provided in entry 501 of the Login GUI by server 28, thereby obviating the need of the operator's eliciting from the user, and entering, the required phone number or username. At entry 504, the operator enters the password provided by the user to complete the login process. In the event that the ANI is not automatically available, or where the user is accessing the subject service from an unknown point or the operator suspects that the user calls from a phone number other than the registered phone number, the operator may verify/obtain the necessary identifying information with/from the user. For that matter, in an alternative embodiment, the user data record may also contain biometric measures for user identification, e.g., voiceprints of the user, which may be derived from a recording of the user uttering a pre-selected code(s) (e.g., PIN) or word(s) (e.g., password) during the registration process. In that embodiment, when the user subsequently attempts to access the personalized information service, the user needs to utter the pre-selected code(s) or word(s). Only when his/her utterance corresponds to the stored voiceprints, should he/she be allowed the service access.

The login information is transmitted to server 28, where it checks the aforementioned user data record to verify the received information. After it is verified, server 28 identifies from the user data record all of the folders including contacts folders and appointments folders associated with the login information (e.g., the ANI), and any user's access rights thereto. For example, for each folder, the user may have the predesignated rights to view, edit, administer, and/or delete the folder. Server 28 presents to terminal 220 a Home GUI, listing all such folders associated with the ANI and thus the user.

FIG. 4 illustrates such a Home GUI, which lists, among others, contacts folders 607 and 609 designated “Company Contacts” and “My Contacts,” respectively. The operator can access each contacts folder, and manage the contacts information in the folder for the user, subject to the user's access rights thereto. For example, the user in this instance has the predesignated right to view the content of Company Contacts folder 607 only. On the other hand, he/she has the additional right to edit the content of My Contacts folder 609.

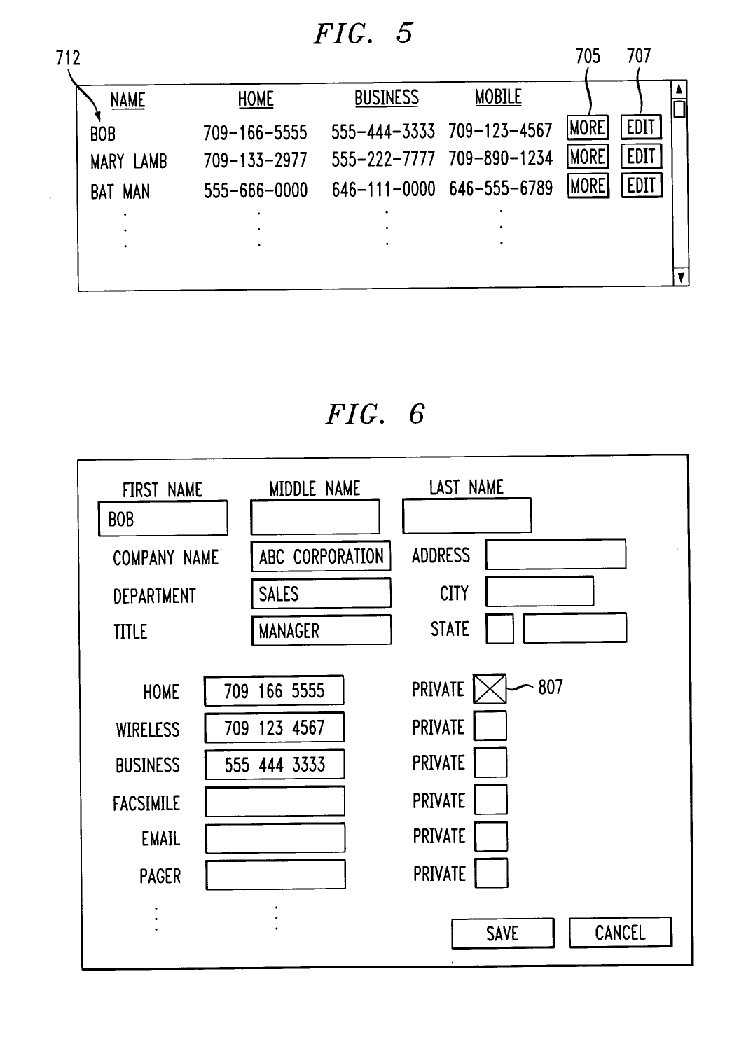

FIG. 5 illustrates a GUI showing the content of My Contacts folder 609 when, say, Edit Contacts option 611 is selected. As shown in FIG. 5, for each contact, e.g., Bob, his/her name, home phone number, business phone number and mobile phone number, if any, although additional information concerning the contact, e.g., his/her postal and electronic mail addresses, may be available but is not displayed for lack of room. For that reason, a More option, e.g., option 705, is provided for selection to present the additional information on a separate screen.

In addition, for each contact an Edit option, e.g., option 707, is provided to edit the contact information. For instance, when option 707 is selected, server 28 returns another GUI, which is illustrated in FIG. 6. At this GUI, different fields concerning the contact Bob, e.g., his name, company name, company address, phone numbers, facsimile numbers and pager numbers are presented, and each field may be modified by overwriting any existing information therein.

It should be noted that to protect privacy of certain information about a contact, e.g., his/her home phone number, an owner or administrator of folder 609 is afforded Private options, e.g., option 807, to designate certain contact information private. Accordingly, server 28 exercises censorship on contact information in a folder based on any privacy protection previously imposed by the owner or administrator of the folder. As shown in FIG. 6, the privacy protection is on an element by element basis. For example, Private option 807 in this instance is selected to keep Bob's home phone number private while the Private option for his business number is unselected, which is therefore unprotected from the public. Thus, in this instance, a read-only subscriber to folder 609 who is not privy to Bob's home phone number may learn his business number. As a result, when a read-only subscriber views a listing of the contacts including Bob in folder 609, his home phone number is replaced by a “Private” notice.

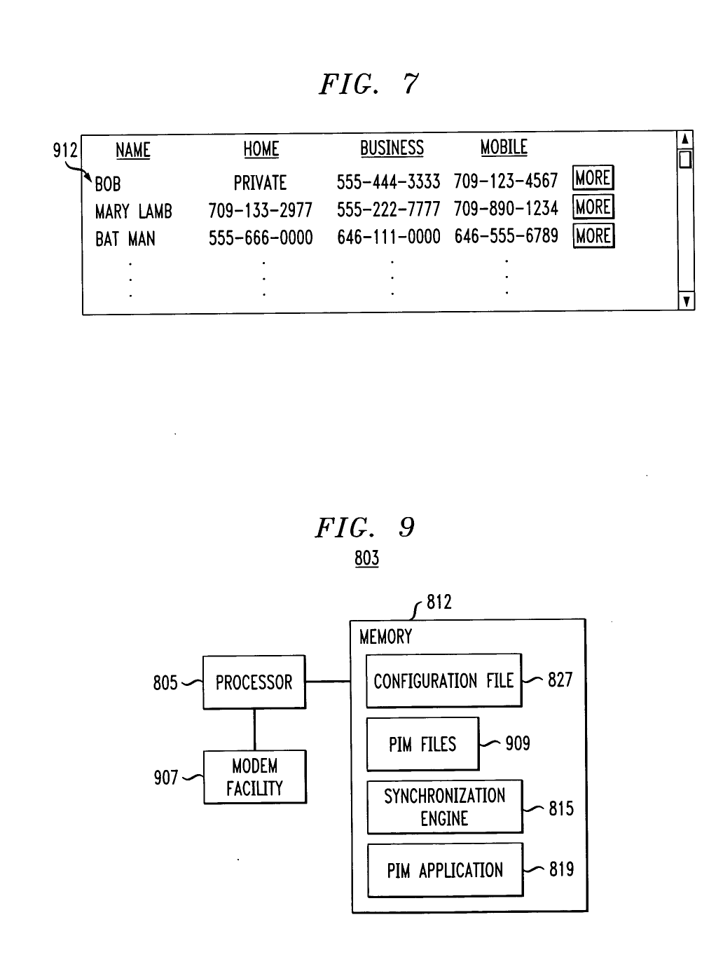

However, the read-only subscriber to folder 609 may still be connected to Bob's home phone number by the operator, but will not be provided with the number dialed. To that end, after the read-only subscriber calls an operator and requests to be connected to Bob, the operator goes through the similar Login and Home GUIs which however pertain to the read-only subscriber. By utilizing the search engine described below, the operator uncovers listing 912 in a View GUI illustrated in FIG. 7.

It should be noted that this View GUI which is made available to a read-only subscriber (represented by the operator in this instance) to folder 609 is similar to the Edit GUI of FIG. 5 which is made available to an owner or administrator of the folder. However, the two GUIs differ from each other in that unlike the Edit GUI, the View GUI lacks Edit options since a read-only subscriber to folder 609 does not possess edit rights. In addition, Bob's home number, designated private, is revealed on the Edit GUI to the owner or administrator of folder 609, but not on the View GUI. Thus, in this instance, the operator is faced with the same “Private” notice in lieu of Bob's home phone number on the View GUI as would be the case if the read-only subscriber accesses the View GUI on his/her own. In order to connect the read-only subscriber to Bob's home number, the operator at terminal 220 signals switching matrix platform 203 to place the read-only subscriber's call on hold, and selects the “Private” notice. This selection causes an identification (ID) of the subscriber's connection which is on hold, and a request for Bob's home number in folder 609 to be sent to server 28. In response to such a request, server 28 retrieves Bob's home number in folder 609 from database 20, and transmits another request for connecting the subscriber to the retrieved phone number to switching matrix host computer 228 via WAN 30. This request includes the aforementioned subscriber's connection ID. Under control of computer 228, platform 203 then calls Bob's home phone number to establish a connection thereto. Once the new connection is established, computer 228 causes platform 203 to bridge the subscriber's connection identified by the received ID to the new connection, thereby connecting the subscriber to Bob's home number, without disclosing the number to the subscriber, or the operator for that matter.

Referring back to FIG. 4, a search engine is provided on a Home GUI to search for a listing of a desired contact. For example, the operator may specify at entry 655 a search term (e.g., Bob), and select at entry 657 the type of folder (e.g., contacts or appointments) in which the search term is to be found. Thus, by using such a search engine, an informal request without much information, such as “I need to reach Bob” and “I want to talk to the sales manager at ABC Corporation” is sufficient for the operator to locate the requested contact information. After initiating the search by clicking on the “Search” button, any listing satisfying the search query is highlighted. In this instance, a search on the name “Bob” in a contacts folder uncovers listing 712 in the Edit GUI of FIG. 5.

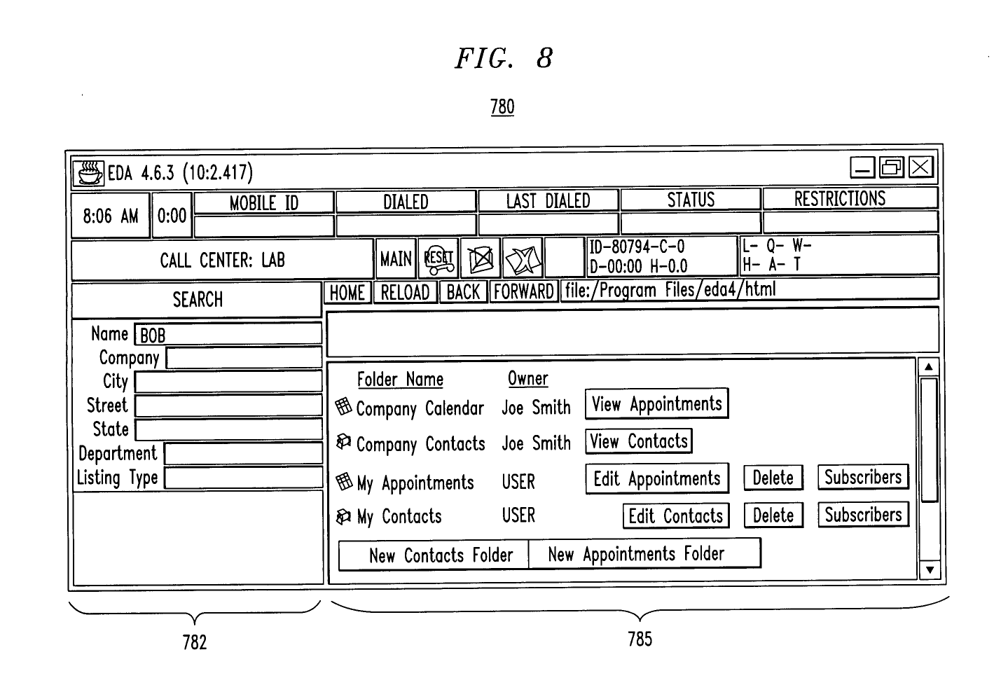

It is anticipated that when given more specific data about the desired contact, e.g., Bob's full name, the operator may also search such other directory databases as public national directory databases, enterprise directory databases (e.g., corporation directory databases, and university directory databases), etc., accessible by database server 226. To that end, GUI 780 in FIG. 8 is designed for the operator to perform such a combined search. As shown in FIG. 8, section 785 of GUI 780 corresponds to the Home GUI of FIG. 4, which allows the operator to manage contacts and appointments folders for the user as described before. In addition, section 782 provides the interface for the operator to perform the combined search for desired contact information.

Thus, in this example, when a user requests a listing of a desired party, say, Bob, the operator invokes GUI 780 on terminal 220. The operator enters at search section 782 the name Bob and any other information provided by the user to the best of his/her ability such as Bob's last name, the name of the company at which Bob works, his or his company's address, etc. In response to, no, or one or more search results meeting the user's request are returned from database server 226 accessing a public national directory database and enterprise directory databases in this instance, and/or from personalized information server 28 accessing folders 607 and 609 associated with the user. Each returned listing in this instance includes a source indicator indicating its provider, i.e., database server 226 or personalized information server 28. If multiple Bob listings are returned, the operator in a conventional manner discusses the listings with the user to ascertain the desired Bob listing. When the desired Bob listing is ascertained and selected by the operator for later possible connection to the listed telephone number for the user, and incorporation into one or more contacts folders associated with the user before the process ends.

### Data Synchronization

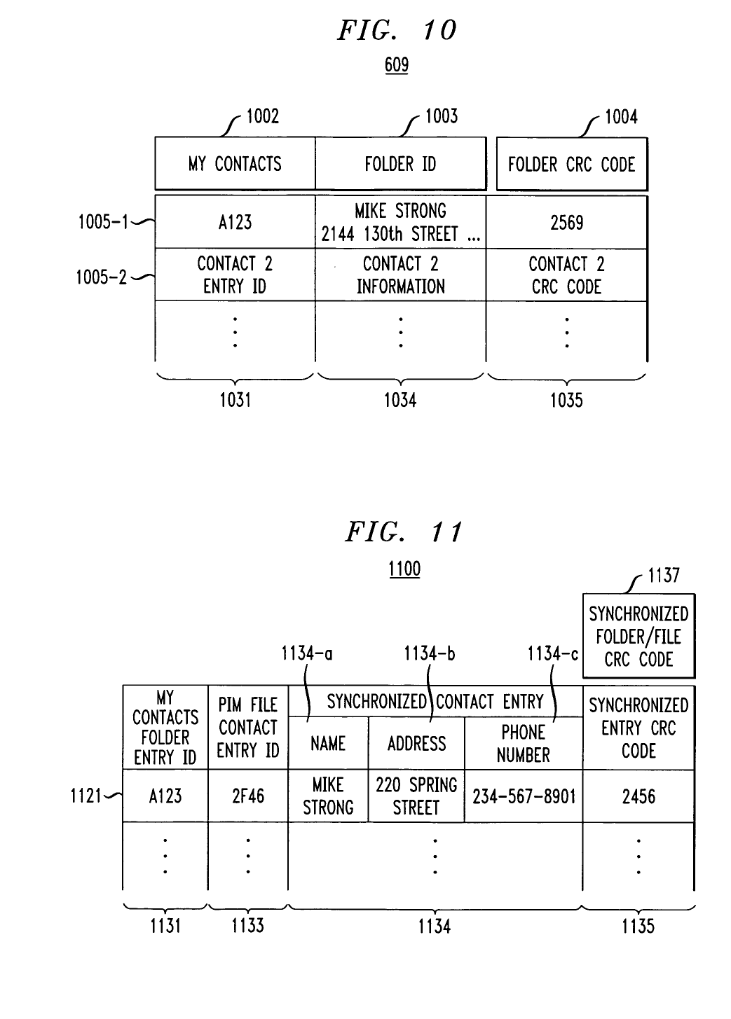

In an embodiment of the invention, a user PIM, e.g., user computer 803 in FIG. 9, may initiate synchronization of its files (denoted 909), e.g., contacts and appointments data files, stored in memory 812 with contacts and appointments folders maintained by server 28 in database 20. Conventional PIM application 819, e.g., a Microsoft Outlook, Outlook Express, Goldmine, Symantec Act!, Lotus Organizer and Lotus Notes application, is installed in computer 803. Also installed in computer 803 is synchronization engine 815. For example, engine 815 may be designed based on a commercially available Intellisync Connector SDK kit provided by Puma Technology, San Jose, Calif. Engine 815 may be downloaded from server 28 via the Internet and is configured according to PIM application 819 used. In configuring engine 815, all of the contacts and appointments folders in database 20 associated with the user are identified. However, only those contacts and appointments folders of which the user is either an owner or administrator can be selected to be synchronized with PIM files 909, stemming from the requirement that a folder can only be modified by its owner or administrator, but not its read-only subscribers. Thus, in this instance, since the user is the owner of My Contacts folder 609 and My Appointments folder 608, the user is afforded options to synchronize folder 609 and/or folder 608 with the corresponding PIM contacts file and/or PIM appointments (calendar) file specified by the user.

Information concerning the association of a PIM file with the corresponding folder for synchronization therewith is stored in configuration file 827. After the initial set-up of engine 815 and configuration file 827, each time when the user creates a folder or becomes an administrator of a folder, the user is afforded an option to associate the folder with the corresponding PIM file for synchronization purposes.

Data synchronization may be initiated by the user or automated by synchronization engine 815 to synchronize the specified folders with the corresponding PIM files from time to time through a communications connection with server 28 established using modem facility 907. For example, engine 815 may be programmed to perform unattended synchronizations at specified times, after computer 803 has been idle for a specified period, or when the user logs on/off computer 803. In addition, engine 815 may be programmed to suspend any automated synchronization while computer 803 is running on battery power.

To realize the data synchronization in accordance with the invention, in this illustrative embodiment server 28 calculates a cyclic redundancy check (CRC) code for each folder, e.g., My Contacts folder 609, and for each contact entry therein. Specifically, server 28 performs a conventional CRC calculation on each contact entry (name, phone number, address, etc., e.g., in ASCII code) in its entirety so that if any part of the contact entry changes so will the CRC code for that contact entry. The CRC code for the folder is calculated based on the CRC codes for the respective contact entries therein. For example, to compute the CRC code for My Contacts folder 609, the CRC codes for the respective contact entries in the folder may first be summed. Server 28 then performs the conventional CRC calculation on the resulting sum to yield the CRC code for folder 609.

In this example, My Contacts folder 609 is illustrated in table form in FIG. 10. As shown in FIG. 10, fields 1003, 1004 and 1005 of folder 609 include the name of the folder, folder ID and current CRC code for the folder, respectively. The folder ID is assigned by server 28 for uniquely identifying the folder within database 20. Folder 609 also includes rows 1005-1, 1005-2, . . . , containing contact entries (name, address, phone number, etc.) concerning, e.g., a contact named “Mike Strong,” contact2, . . . , respectively. Rows 1005-1, 1005-2, . . . also contain their respective entry LDs and CRC codes. The entry IDs are assigned by server 28 for uniquely identifying the entries within the folder. For example, row 1005-1 contains Mike Strong's contact information including his address 2144 130^{th} Street . . . ; which entry is assigned “A123 (hexadecimal)” as its ID; and the CRC code therefor is illustratively “2569 (hexadecimal)” in this instance. Server 28 updates folder 609 each time when a contact entry therein is edited, deleted or added.

Server 28 also maintains a synchronization reference table denoted 1100 in FIG. 11, which contains information resulting from the last synchronization. The content and use of table 1100 are fully described below. It suffices to know for now that server 28 relies on table 1100 during a synchronization process to determine whether any entry of My Contacts folder 609 and/or the corresponding PIM contacts file (e.g., an Outlook contacts file) for synchronization therewith has been changed since the last synchronization. As shown in FIG. 11, column 1131 of table 1100 contains the respective IDs of My Contacts folder entries as of the last synchronization. Column 1133 contains the respective IDs of the PIM contact entries synchronized with the corresponding folder contact entries. The IDs of each pair of synchronized PIM contact entry (e.g., “2F46”) and folder contact entry (e.g., “A123”) appear in the same row (e.g., row 1121) of table 1100. The PIM contact entries' IDs are assigned by PIM application 819 for uniquely identifying them within the PIM contacts file. Column 1134 contains the synchronized contact entries resulting from the last synchronization. The contact information in each entry in column 1134 populates predetermined fields, e.g., name field 1134-a, address field 1134-b, phone number field 1134-c, etc. Column 1135 contains the CRC codes for the respective synchronized contact entries as of the last synchronization. It should be noted that the contents of columns 1131, 1134 and 1135 were identical to those of columns 1031, 1034 and 1035 at the end of the last synchronization. However, the contents of columns 1031, 1034 and 1035 are kept current and may have been changed since the last synchronization to reflect any instant additions, deletions and/or edits of one or more My Contacts folder entries, while the contents of columns 1131, 1134 and 1135 remain the same until the time of a second synchronization in which one or more entries in folder 609 and/or the corresponding PIM contact file are deleted, added and/or edited. For example, at the end of the last synchronization, My Contacts Folder entry A123 had Mike Strong's address as “220 Spring Street,” as indicated in row 1121 of table 1100. However, since the last synchronization, the user has changed Mike Strong's address in My Contacts folder 609 to “2144 130^{th} Street,” as indicated in row 1005-1 of FIG. 10.

Field 1137 of table 1100 contains a CRC code for the synchronized file/folder. In this illustrative embodiment, server 28 sums the individual CRC codes for the synchronized entries in column 1135, and performs a CRC calculation on the resulting sum to yield the CRC code 1137 for the synchronized file/folder. Thus, CRC code 1004 and CRC code 1137 had the same value at the end of the last synchronization. However, the value of CRC code 1004 is kept current and may have been changed since the last synchronization to reflect any instant modifications of folder 609 while the value of CRC code 1137 remains the same until the time of a second synchronization in which one or more entries in folder 609 and/or the corresponding PIM contacts file is modified.

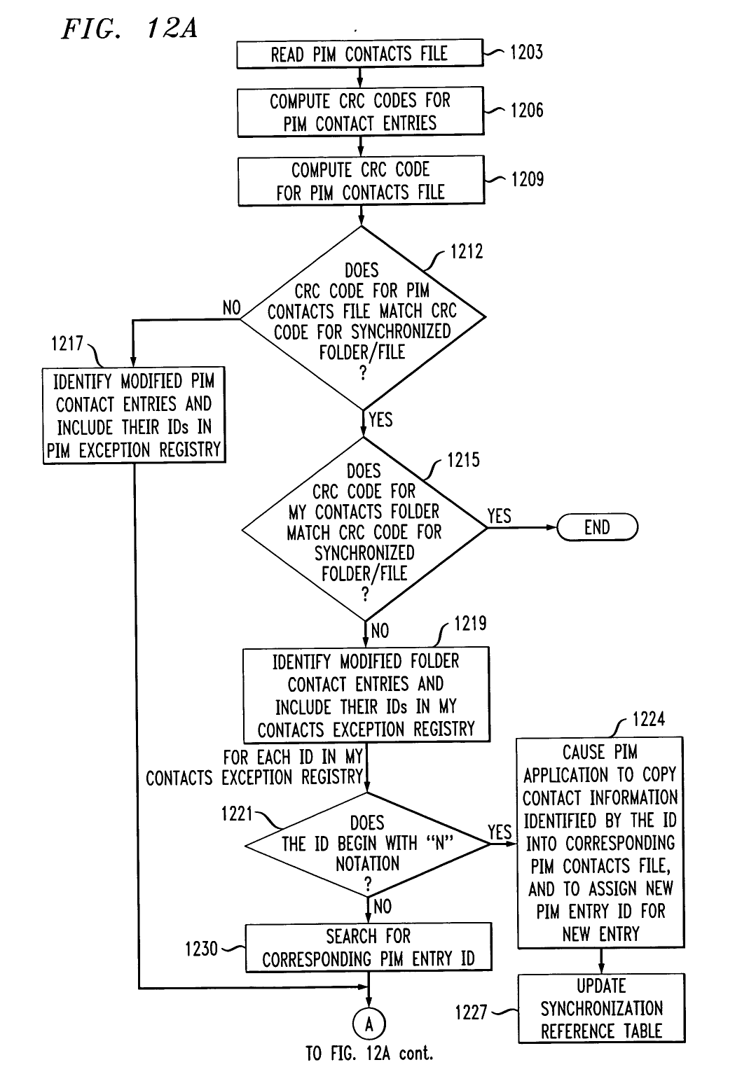

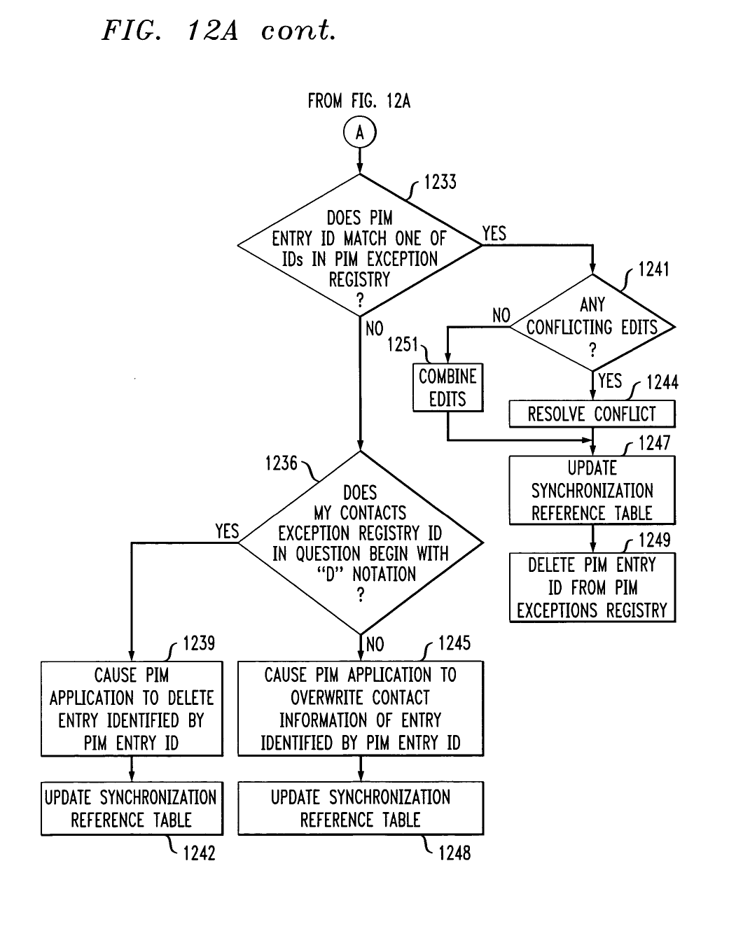

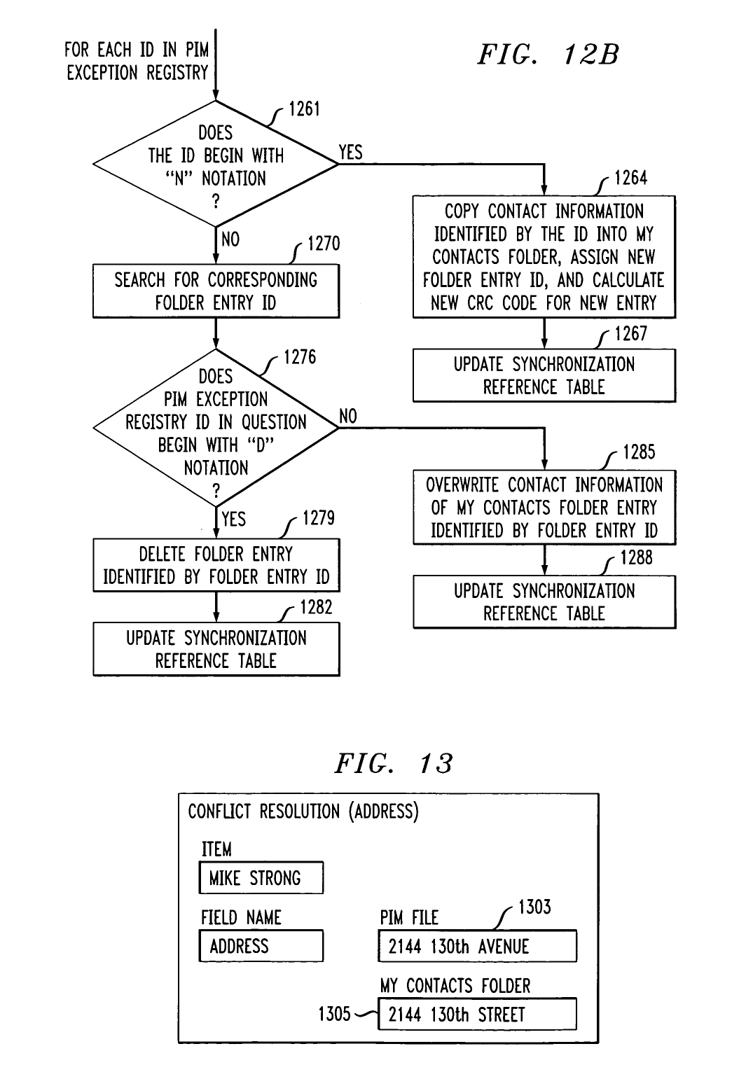

FIGS. 12A and 12B illustrate the synchronization process in accordance with the invention, which in this instance server 28 performs to synchronize My Contacts folder 609 in database 20 with the corresponding PIM contacts file in user computer 803. Upon initiation of a synchronization, server 28 reads the PIM contacts file in user computer 803, as indicated at step 1203 in FIG. 12A. Server 28 at step 1206 computes CRC codes for the respective contact entries in the PIM contacts file. At step 1209, server 28 computes a CRC code for PIM contacts file based on the CRC codes for the contact entries in the file computed in step 1206. At step 1212, server 28 determines whether the CRC code for the PIM contacts file matches CRC code 1137 for the synchronized file/folder from table 1100. If so, server 28 at step 1215 further determines whether CRC code 1004 for My Contacts folder 609 of FIG. 10 matches CRC code 1137 for the synchronized file/folder. If so, the synchronization process comes to an end as no changes have been made to My Contacts folder 609 and the corresponding PIM contacts file since the last synchronization.

Otherwise, if server 28 at step 1212 determines that the CRC code for the PIM contacts file does not match CRC code 1137 for the synchronized file/folder, server 28 concludes that the PIM contacts file has been modified since the last synchronization. Accordingly, server 28 at step 1217 identifies the modified PIM contact entries and include their IDs in a PIM exception registry. To identify the modified PIM contact entries, for each ID of a PIM entry in the PIM file read in step 1203, server 28 attempts to locate a synchronized entry having the same ID in column 1133 of table 1100. If such a pair is found, server 28 compares the CRC code calculated in step 1206 for the PIM entry in question with the CRC code for the corresponding synchronized entry in column 1135. If the two CRC codes match, server 28 concludes that no change has been made to the entry in question since the last synchronization. Otherwise, if the two CRC codes do not match, server 28 concludes that the entry in question has been modified, and enters its ID in the PIM exception registry.

If server 28 cannot locate, in column 1133, any PIM file entry ID read in step 1203, server 28 concludes that the entry ID in question identifies a new entry which has been added to the PIM file since the last synchronization. Server 28 also enters the ID in question in the PIM exception registry, e.g., with a notation “N” preceding the ID, indicating its “new” status. Conversely, if server 28 identifies an ID in column 1133 which does not match any entry ID read in step 1203, server 28 concludes that the ID in column 113 identifies an entry which has been deleted from the PIM file since the last synchronization. Server 28 also enters the ID of the deleted entry in the PIM exception registry, e.g., with a notation “D” preceding the ID, indicating its “deleted” status.

Similarly, if server 28 at step 1215 determines that the CRC code for My Contacts folder 609 does not match CRC code 1137 for the synchronized file/folder, server 28 concludes that My Contacts folder 609 has been modified since the last synchronization. Accordingly, server 28 at step 1219 identifies the modified folder entries and include their IDs in a My Contacts exception registry. To identify the modified folder entries, for each My Contacts folder entry ID in column 1031 of FIG. 10, server 28 attempts to locate a synchronized entry having the same ID in column 1131 of table 1100. If such a pair is found, server 28 compares the CRC code for the folder entry in question in column 1035 with the CRC code for the corresponding synchronized entry in column 1135. If the two CRC codes match, server 28 concludes that no change has been made to the entry in question since the last synchronization. Otherwise, if the two CRC codes do not match, server 28 concludes that the entry in question has been modified, and enters its ID in the My Contacts exception registry.

If server 28 cannot locate, in column 1131, any folder entry ID from column 1031, server 28 concludes that the entry ID in question identifies a new entry which has been added to My Contacts folder 609 since the last synchronization. Server 28 also enters the ID in question in the My Contacts exception registry, e.g., with a notation “N” preceding the ID, indicating its “new” status. Conversely, if server 28 identifies an ID in column 1131 which does not match any entry ID from column 1031, server 28 concludes that the ID in column 1131 identifies an entry which has been deleted from My Contacts folder 609 since the last synchronization. Server 28 also enters the ID of the deleted entry in the My Contacts exception registry, e.g., with a notation “D” preceding the ID, indicating its “deleted” status.

For each ID in My Contacts exception registry, server 28 at step 1221 determines whether the ID, which identifies a modified contact entry in My Contacts folder 609, begins with an “N” notation, indicating its “new” status. If it does, server 28 at step 1224 causes PIM application 819 to copy the contact information in folder 609 of FIG. 10 identified by the ID in question into the corresponding PIM contacts file, and to assign a new PIM entry ID for the new entry. At step 1227, server 28 updates synchronization reference table 1100 to include the new contact information in column 1134, and the corresponding My Contacts folder entry ID in column 1131 and the newly assigned PIM file entry ID in column 1133, etc.

Otherwise, if it is determined that the My Contacts folder ID in question does not begin with an “N” notation, server 28 at step 1230 searches table 1100 for the PIM file contact entry ID corresponding to the ID in question. At step 1233 server 28 determines whether the PIM file entry ID found in step 1230 matches one of the IDs in the PIM exception registry from step 1217. If not, server 28 at step 1236 further determines whether the My Contacts exception registry ID in question begins with a “D” notation. If so, server 28 at step 1239 causes PIM application 819 to delete, from the PIM contacts file, the PIM file contact entry identified by the entry ID found in step 1230, and at step 1242 updates synchronization reference table 1100 by deleting therefrom the row containing the contact entry in question.

Otherwise, if it is determined that the My Contacts folder entry ID in question does not begin with a “D” notation, server 28 at step 1245 causes PIM application 819 to overwrite the contact information of the PIM file entry identified by the entry ID found in step 1230 with that of the My Contacts folder entry identified by the ID in question. Accordingly, server 28 at step 1248 updates the contact information in column 1134, and the CRC code for the modified contact information in column 1135 of synchronization reference table 1100.

Referring back to step 1233, if it is determined that the PIM file entry ID found in step 1230 matches one of the if IDs in the PIM exception registry, server 28 concludes that both of the identified PIM file entry and My Contacts folder entry have been edited. Server 28 at step 1241 determines whether the edits are conflicting. To make such a determination, server 28 compares the edited PIM file contact entry and the edited My Contacts folder entry respectively with the synchronized contact entry in table 1100 from the row containing both IDs of the PIM file entry and the folder entry. Server 28 further determines a first set of fields (e.g., address, phone number, email address fields) in which the edited PIM file contact entry differs from the synchronized contact entry, and a second set of fields in which the edited My Contacts folder entry differs from the synchronized contact entry. If the first and second sets of fields have one or more common fields, server 28 would conclude that the edits are conflicting. In that case, server 28 resolves the conflict by asking the user to select the desired edit from the conflicting edits, as indicated at step 1244.

Let's say the user has modified the address portion of the My Contacts folder entry A123, and the address portion of the corresponding PIM file entry 2F46 since the last synchronization. Referring to row 1121 of table 1100, at the end of the last synchronization, the address portions of My Contacts folder entry A123 and PIM file entry 2F46 were synchronized, which both were “220 Spring Street.” Furthering the example, since the last synchronization, the address of My Contacts folder entry A123 has been changed to “2144 130^{th} Street,” as illustrated in row 1005-1 of FIG. 10. In addition, the address of PIM file entry 2F46 has been changed to “2144 130^{th} Avenue.” By comparing edited entries A123 and 2F46 with the corresponding synchronized contact entry in row 1121, server 28 determines that there are conflicting address edits. For example, to resolve such a conflict, server 28 may provide a GUI, illustrated in FIG. 13, on computer 803, requesting the user to select (e.g., by pointing and clicking) the desired address edit from conflicting address edits 1303 and 1305. The selected address edit is then adopted in both My Contacts folder entry A123 and PIM file entry 2F46.

After resolving the conflict in step 1244, server 28 at step 1247 updates synchronization reference table 1100 with the new synchronized contact information, and the new CRC code therefor. Server 28 at step 1249 deletes the PIM entry ID in question from the PIM file exception registry to avoid duplicate synchronization efforts when the PIM file exception registry is processed in the second part of the synchronization process, described below with reference to FIG. 12B.

Referring back to step 1241, if it is determined that the edits are non-conflicting, e.g., a first change in the address of My Contacts folder entry A123 and a second change in the phone number of corresponding PIM file contact entry 2F46, server 28 at step 1251 generates a synchronized entry adopting the non-conflicting edits, which replaces the outdated versions of entries A123 and 2F46 in this instance. The subject routine then proceeds to step 1247 described before.

FIG. 12B illustrates the second part of the synchronization process in accordance with the invention, where for each ID in the PIM exception entry, server 28 at step 1261 determines whether the ID, which identifies a modified contact entry in the PIM file, begins with an “N” notation, indicating its “new” status. If it does, server 28 at step 1264 copies the contact information in the PIM file identified by the ID in question into My Contacts folder 609, assigns a new folder entry ID and calculates a new CRC code for the new entry. At step 1267, server 28 updates synchronization reference table 1100 to include the new contact information in column 1134, PIM entry ID in question in column 1133 and the corresponding new folder entry ID in column 1131.

Otherwise, if it is determined that the PIM exception entry ID in question does not begin with an “N” notation, server 28 at step 1270 searches table 1100 for the My Contacts folder entry ID corresponding to the ID in question. At step 1276 server 28 determines whether the PIM entry ID in question begins with a “D” notation. If so, server 28 at step 1279 deletes, from My Contacts folder 609, the folder entry identified by the entry ID found in step 1270, and at step 1282 updates synchronization reference table 1100 by deleting therefrom the row containing the contact entry in question.

Otherwise, if it is determined that the PIM entry ID in question does not begin with a “D” notation, server 28 at step 1285 overwrites the contact information of the My Contacts folder entry identified by the entry ID found in step 1270 with that of the PIM file entry identified by the ID in question. Accordingly, server 28 at step 1288 updates the contact information in column 1134, and the CRC code for the modified contact information in column 1135 of synchronization reference table 1100.

Once the synchronization process of FIGS. 12A and 12B is completed, server 28 computes the new CRC code for the synchronized folder/file to update both field 1137 of table 1100 and field 1004 of My Contacts folder 609.

The foregoing merely illustrates the principles of the invention. It will thus be appreciated that those skilled in the art will be able to devise numerous other arrangements which embody the principles of the invention and are thus within its spirit and scope.

For example, in the disclosed embodiment, the inventive technique is applied to synchronize contacts data between different contacts data sources. However, the application of the inventive synchronization technique is not limited to a particular type of data. Rather, the inventive technique can be applied to synchronize any sorts of data between data sources, including, but not limited to, appointments (calendar) data, to-do-lists, etc.

In addition, in the disclosed embodiment, CRC codes are used to represent the contents for comparison based on which the codes are calculated. However, other codes, e.g., digital signatures resulting from signing the contents using hash functions, ciphertext resulting from encrypting the contents, etc., may be used to represent the contents for comparison, instead.

Further, the invention equally applies regardless of whether feature group D (FGD) type signaling, SS7 out-of-band signaling or other signaling is used for communications between carrier switches and switching matrix platform 203 of FIG. 2A.

Finally, information/call center 200 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for providing data synchronization through an information service, comprising:
maintaining by the information service a first data source associated with a user, the first data source being accessible to at least one device associated with the user, the device including a second data source;
maintaining a first representation of synchronized content resulting from a previous synchronization of contents of the first data source and the second data source;
generating a second representation of content of the first data source after the previous synchronization;
generating a third representation of content of the second data source after the previous synchronization;
determining at least one change in the content of at least one of the first data source and the second data source since the previous synchronization by comparing the first representation with the second and third representations, respectively; and
performing a current synchronization between the first data source and the second data source based on the change.

2. The method of claim 1 wherein the first data source contains one or more information entries, and the second data source contains one or more information entries.

3. The method of claim 2 further comprising maintaining a first set of representations of synchronized information entries resulting from the previous synchronization, and upon determining that the change is in the content of the first data source, comparing the first set of representations with a second set of representations of the respective information entries in the first data source after the previous synchronization to determine one or more modifications in the information entries of the first data source since the previous synchronization, the current synchronization being at least a function of the one or more modifications.

4. The method of claim 3 further comprising identifying one or more information entries in the second data source corresponding to one or more information entries in the first data source affected by the one or more modifications.

5. The method of claim 2 further comprising, upon determining that the change is in the content of the second data source, comparing the first set of representations with a third set of representations of the respective information entries in the second data source after the previous synchronization to determine at least one modification in the information entries of the second data source since the previous synchronization, the current synchronization being a function of the at least one modification.

6. The method of claim 5 further comprising identifying one or more information entries in the first data source corresponding to one or more information entries in the second data source affected by the at least one modification.

7. The method of claim 1 further comprising resolving any conflict between changes in the contents of the first data source and the second data source.

8. The method of claim 1 wherein at least one of the first, second and third representations includes a cyclic redundancy check (CRC) code.

9. The method of claim 1 wherein at least one of the first, second and third representations includes a digital signature.

10. The method of claim 1 wherein the first and second data sources contain contacts information.

11. The method of claim 1 wherein the first and second data sources contain appointments information.

12. A system for providing data synchronization through an information service, comprising:
a first data source maintained by the information service, the first data source being associated with a user and accessible to at least one device associated with the user, the device including a second data source, a first representation being maintained which is representative of synchronized content resulting from a previous synchronization of contents of the first data source and the second data source;
a processing unit configured to generate a second representation of content of the first data source after the previous synchronization, a third representation being generated which is representative of content of the second data source after the previous synchronization, the processing unit determining a change in the content of at least one of the first and second data sources since the previous synchronization by comparing the first representation with the second and third representations, respectively; and
a mechanism for performing a current synchronization between the first data source and the second data source based on the change.

13. The system of claim 12 wherein the first data source contains one or more information entries, and the second data source contains one or more information entries.

14. The system of claim 13 wherein a first set of representations of synchronized information entries is maintained which results from the previous synchronization, and upon determining that the change is in the content of the first data source, the first set of representations is compared with a second set of representations of the respective information entries in the first data source after the previous synchronization to determine one or more modifications in the information entries of the first data source since the previous synchronization, the current synchronization being at least a function of the one or more modifications.

15. The system of claim 14 wherein one or more information entries in the second data source are identified which correspond to one or more information entries in the first data source affected by the one or more modifications.

16. The system of claim 13 wherein, upon determining that the change is in the content of the second data source, the first set of representations is compared with a third set of representations of the respective information entries in the second data source after the previous synchronization to determine at least one modification in the information entries of the second data source since the previous synchronization, the current synchronization being a function of the at least one modification.

17. The system of claim 16 wherein one or more information entries in the first data source are identified which correspond to one or more information entries in the second data source affected by the at least one modification.

18. The system of claim 12 further comprising resolving any conflict between changes in the contents of the first data source and the second data source.

19. The system of claim 12 wherein at least one of the first, second and third representations includes a CRC code.

20. The system of claim 12 wherein at least one of the first, second and third representations includes a digital signature.

21. The system of claim 12 wherein the first and second data sources contain contacts information.

22. The system of claim 12 wherein the first data and second data sources contain appointments information.

23. Software recorded in a tangible medium which includes machine readable instructions for performing a process for providing data synchronization through an information service, comprising:
maintaining by the information service a first data source associated with a user, the first data source being accessible to at least one device associated with the user, the device including a second data source;
maintaining a first representation of synchronized content resulting from a previous synchronization of contents of the first data source and the second data source;
generating a second representation of content of the first data source after the previous synchronization;
generating a third representation of content of the second data source after the previous synchronization;
determining at least one change in the content of at least one of the first and second data sources since the previous synchronization by comparing the first representation with the second and third representations, respectively; and
performing a current synchronization between the first data source and the second data source based on the change.
